(19) United States
(12) Patent Application Publication
(10) Pub. No.: US 2015/0263472 A1
(43) Pub. Date: Sep. 17, 2015

(54) HYDRAULICALLY ACTUATED TOOL

(71) Applicant: LEGEND CORPORATE SERVICES PTY LTD, Hendon (AU)

(72) Inventor: Michael Sneath, Bayswater North (AU)

(21) Appl. No.: 14/438,614

(22) PCT Filed: Oct. 9, 2013
(86) PCT No.: PCT/AU2013/001165

§ 371 Date: Apr. 24, 2015

(30) Foreign Application Priority Data
Oct. 26, 2012 (AU) 2012904739

(51) Int. Cl. H01R 43/042; B25B 27/10; B25B 27/14

(52) U.S. Cl. CPC H01R 43/0427; B25B 27/146; B25B 27/10

(57) ABSTRACT

An hydraulically actuated tool has a body, an hydraulic fluid supply, a head chamber and an actuable member adapted to be actuated by pressure within the head chamber. An hydraulic drive arrangement is configured to draw hydraulic fluid from the hydraulic fluid supply and drive the hydraulic fluid under increasing pressure into the head chamber. An indicator assembly is mounted in the body and has an indicator member displaceable between a retracted position and an extended position protruding from the body. A pressure relief valve assembly is adapted to open upon pressure within the head chamber reaching a predetermined threshold pressure. Opening of the pressure relief valve assembly communicates the head chamber with the indicator assembly to drive the indicator member to the extended position and communicates the head chamber with the hydraulic fluid supply.

### FIELD OF THE INVENTION

The present invention relates to an hydraulically actuated tool, such as an hydraulic crimping tool.

### BACKGROUND OF THE INVENTION

Hydraulic crimping tools are used in the electrical industry for crimping connectors and splices to cables. Typically an end of a cable to be spliced or connected is positioned in a suitable splice or connector, and a crimping tool is used to crush or crimp the splice or connector onto the cable, thereby causing the splice or connector to be crushed onto the cable such that it grippingly engages with it and provides an electrical coupling.

The splice or connector has to have sufficient strength to resist the tensile forces created by the combined weight of the cables as they hang, and the splice or connector has to be crushed against the cable with sufficient crushing force to ensure a proper electrical connection. The connector or splice needs to be strong enough to be suitable for this type of application. It therefore requires significant crushing force to be able to deform the connector or splicer onto the cable.

Hydraulic crimping tools are able to provide the crushing force required to deform the connector or splice. These are typically either manually or electrically operated. For many industrial applications, such as electrical utility applications, the pressure that the jaws need to apply to the splice or connector can be as high as 10,000 psi (about 70 mPa) or greater.

A crimping operation using an hydraulically actuated crimping tool involves placing the splice or connector to be crimped on to a cable, then positioning the crimping tool in the appropriate location on the splice or connector, and then pulling a trigger that causes a power supply, such as a battery, to energise an electric motor which operates on at least one pump to cause hydraulic fluid to flow from a reservoir through at least one valve and to operate a set of moveable jaws which provide the crushing force needed to execute the crimp. It is common for one of the jaws to be fixed, and the other jaw to be movable toward it under hydraulic pressure.

To ensure that the crushing force applied by the jaws does not exceed that necessary to ensure a satisfactory crimp, as may be specifically mandated by authorities such as government agencies, utility companies or manufacturers of particular splicers or connectors, means may be provided to release the hydraulic pressure in the tool at a set pressure threshold. This signals the end of the crimping operation.

### SUMMARY OF THE INVENTION

The present invention provides an hydraulically actuated tool comprising:

a body;

an hydraulic fluid supply;

a head chamber;

an actuable member adapted to be actuated by pressure within said head chamber;

an hydraulic drive arrangement configured to draw hydraulic fluid from said hydraulic fluid supply and drive said hydraulic fluid under increasing pressure into said head chamber;

an indicator assembly mounted in said body and having an indicator member displaceable between a retracted position and an extended position protruding from said body; and

a pressure relief valve assembly adapted to open upon pressure within said head chamber reaching a predetermined threshold pressure;

wherein opening of said pressure relief valve assembly communicates said head chamber with said indicator assembly to drive said indicator member to said extended position and communicates said head chamber with said hydraulic fluid supply.

Typically, said indicator assembly further comprises a spring biasing said indicator member to said retracted position.

In one form, in said extended position, said indicator member extends through an opening provided in a recessed region of an outer surface of said body.

In a preferred form, said pressure relief valve assembly comprises:

a relief valve chamber;

an inlet port located at an upstream end of said relief valve chamber and communicating with said head chamber.

a primary outlet port located at a downstream end of said relief valve chamber and communicating with said hydraulic fluid supply;

a secondary outlet port located between said inlet port and said primary outlet port and communicating with said indicator assembly;

a relief valve member located in said relief valve chamber, said relief valve member being displaceable between a closed position sealing said inlet port to at least substantially prevent flow of hydraulic fluid through said inlet port and an open position allowing the flow of hydraulic fluid through said inlet port, out of said secondary outlet port and around said relief valve member through said outlet port; and

a relief valve spring biasing said relief valve member to said closed position.

Preferably, opening of said pressure relief valve communicates said inlet port with said hydraulic pressure supply via a restricted flow path.

### BRIEF DESCRIPTION OF THE DRAWINGS

A preferred embodiment of the present invention will now be described, by way of an example only, with reference to the accompanying drawings wherein:

FIG. 1 is a perspective view of an hydraulic crimping tool;

FIG. 2 is an exploded perspective view of the hydraulic crimping tool of FIG. 1;

FIG. 3 is an enlarged exploded perspective view of the body assembly of the hydraulic crimping tool of FIG. 1;

FIG. 4 is a side elevation view of the high pressure relief valve assembly of the hydraulic crimping tool of FIG. 1;

FIG. 5 is a perspective view of the high pressure relief valve assembly of FIG. 4;

FIG. 6 is a cross-sectional view of the high pressure relief valve of FIG. 4;

FIG. 7 is a cross-sectional view of the indicator assembly of the hydraulic crimping tool of FIG. 1, mounted in the body block;

FIG. 8 is a cross-sectional view of the indicator assembly and body block of FIG. 6;

FIG. 9 is a cross-sectional view of a shuttle valve assembly of the hydraulic crimping tool of FIG. 1;

FIG. 10 is a schematic view of the hydraulic crimping tool on FIG. 1 at commencement of a crimping operation; and

FIG. 11 is a schematic view of the hydraulic crimping tool of FIG. 1 at completion of a crimping operation.

### DETAILED DESCRIPTION

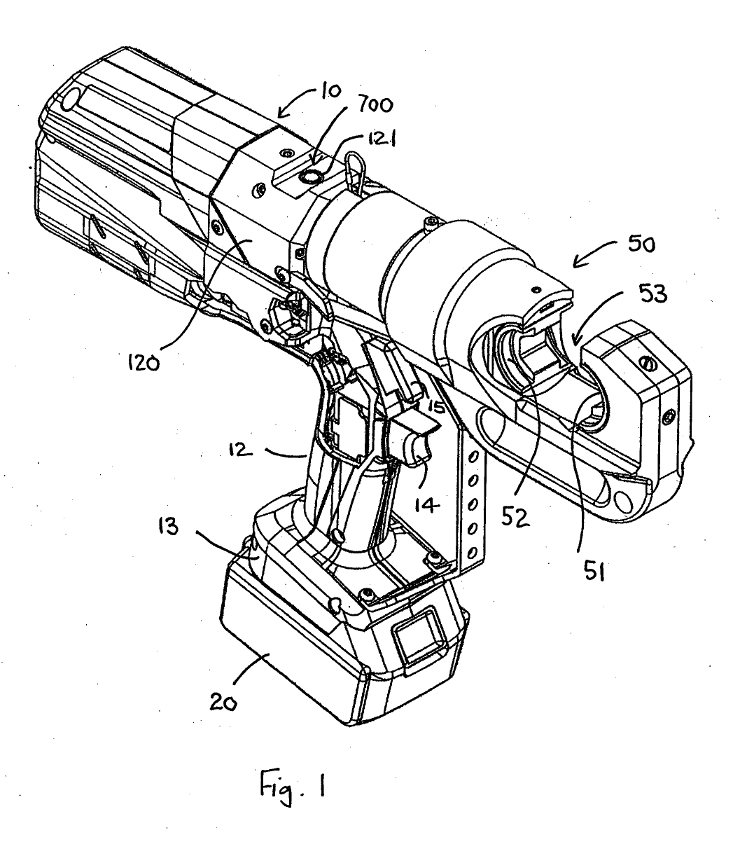

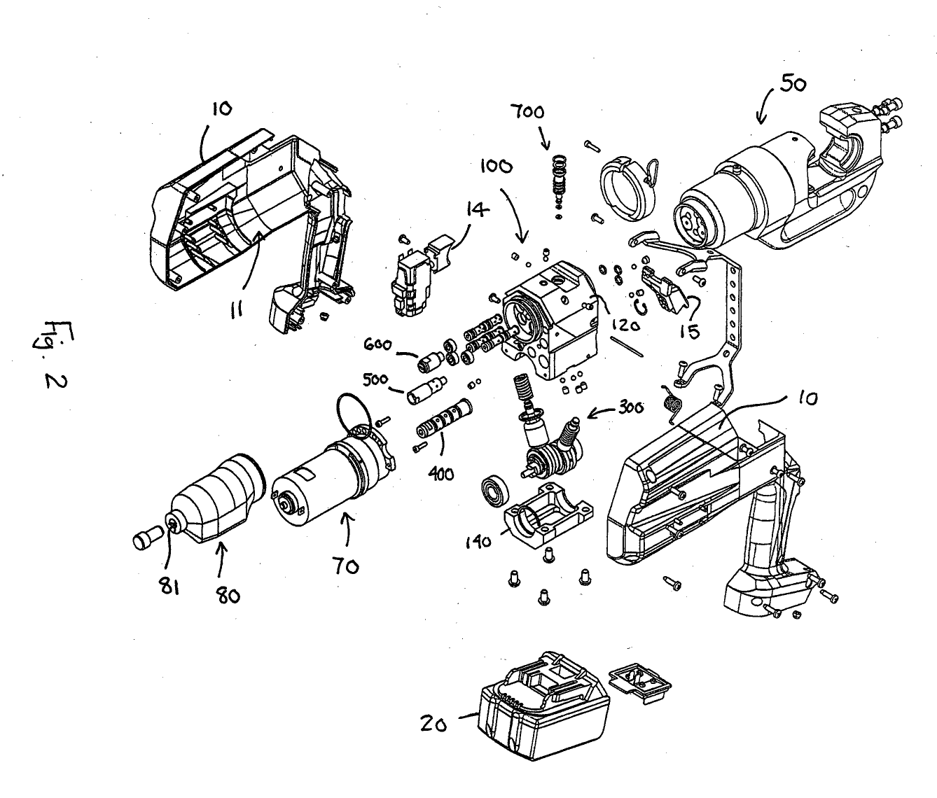

FIGS. 1 and 2 of the accompanying drawings depict an hydraulically actuated tool, in the form of an hydraulic crimping tool. The crimping tool has a two-part casing 10 defining a housing 11 for receipt of various functional components of the tool, as will be described in detail below, and an operator handle 12 depending from the housing 11. The base 13 of the handle 12 is configured to receive a battery pack 20 to electrically power the tool. An operating trigger 14 is mounted on the front of the handle 12. The tool has a head assembly 50 having first and second opposing jaws 51, 52 with a recess 53 defined therebetween for receipt of a connector or splice to be crimped. The first jaw 51 is fixed whilst the second jaw 52 is an actuable member that, in operation, is displaced towards the first jaw 51 under pressure to crimp the connector or splice between the first and second jaws 51, 52.

Referring specifically to FIG. 2, within the housing 11 is mounted a body assembly 100, a motor and gearbox assembly 70 and a bladder 80 defining an hydraulic fluid supply 81.

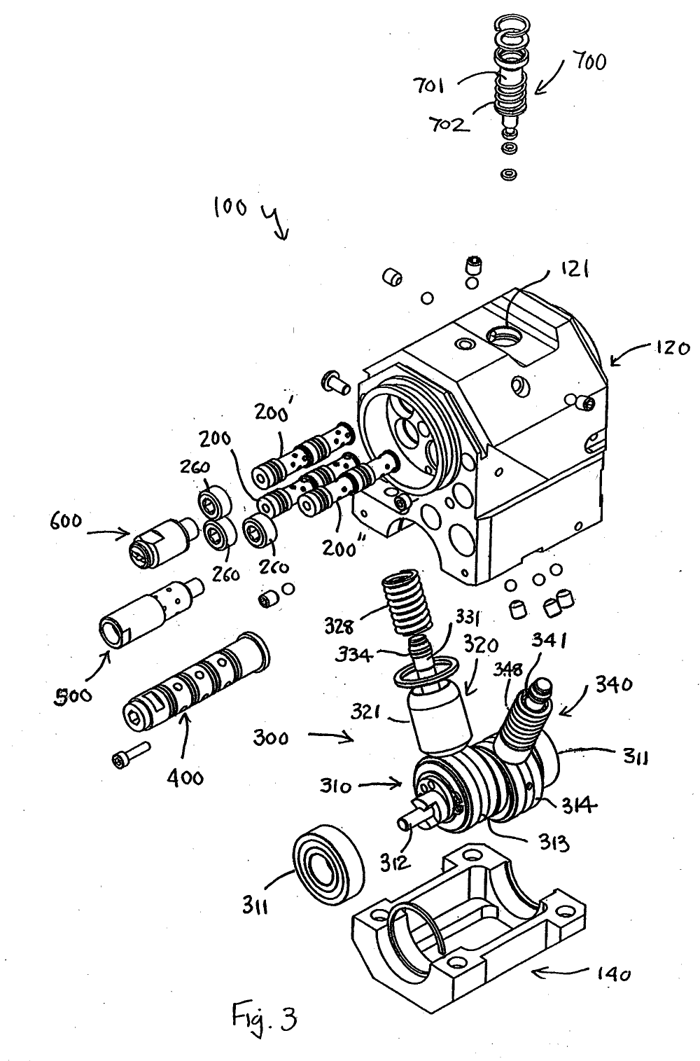

The body assembly 100 is depicted in greater detail in FIG. 3. The body assembly 100 comprises a body block 120, a body base 140, first, second and third shuttle valve assemblies 200, 200′, 200″ mounted in the body block 120, a pump assembly 300 mounted between the body block 120 and body base 140, a head pressure return valve assembly 400 mounted in the body block 120, a high pressure relief valve assembly 500 mounted in the body block 120 and a low pressure relief valve assembly 600, also mounted in the body block 120. An indicator assembly 700 is mounted in the top of the body block 120 and projects through an opening 121 in the top of the body block 120, as best depicted in FIG. 1.

The pump assembly 300 comprises a cam shaft assembly 310, that is mounted between the body block 120 and body base 140 by way of a pair of bearings 311, and first and second pumps having first and second piston assemblies 320, 340, respectively, which extend into the body block 120. The cam shaft assembly 310 comprises a cam shaft that is in the form of a crankshaft 312 and that is rotatably driven by way of the motor and gearbox assembly 70, and a pair of offset roller bearings that act as first and second cam lobes 313, 314 that drive the first and second piston assemblies 320, 340 respectively as the crankshaft 312 rotates. The first and second cam lobes 313, 314 are here offset by 180 degrees such that the first and second piston assemblies 320, 340 are driven in opposing phases.

The first piston assembly 320 is here of a dual piston configuration, comprising a first piston 321, a second piston 331 and a first spring 328. The base of the first piston 321 defines a first cam follower face 323 which engages the first cam lobe 313. The second piston 331 is received in, and extends from, a recess defined by the first piston 321. The first spring 328 is a compression spring and is mounted on the second piston 331. The first piston assembly 320 is mounted in a first piston mounting cavity 122 formed in the lower face of the body block 120. The first piston mounting cavity 122 has a larger diameter lower region defining a first piston chamber 123 and a smaller diameter upper region defining a second piston chamber 124. The first piston chamber 123 receives the first piston 321. The second piston chamber 124 receives the second piston 331. The first spring 328 biases the first piston assembly 320 towards the cam shaft assembly 310, maintaining engagement of the first cam follower face 323 with the first cam lobe 313.

The second piston assembly 340 is of a single piston configuration, comprising a third piston 341 and a second spring 348. The base of the third piston 341 defines a second cam follower face 343 which engages the second cam lobe 314. The third spring 348 is a compression spring and is mounted on the third piston 341. The second piston assembly 340 is mounted in a second piston mounting cavity 125 formed in the lower face of the body block 120. The second piston mounting cavity 125 has a larger diameter lower region and a smaller diameter upper region defining a third piston chamber 126. The third piston chamber 126 receives the third piston 341. The second spring 348 biases the second piston assembly 340 towards the cam shaft assembly 310, maintaining engagement of the second cam follower face 343 with the second cam lobe 314.

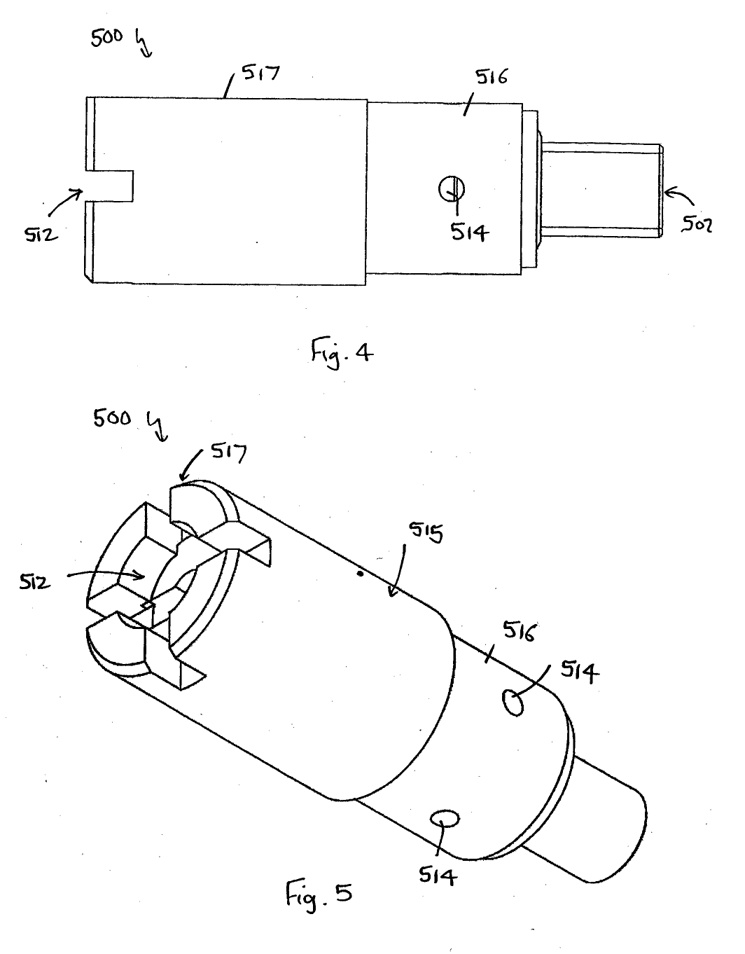

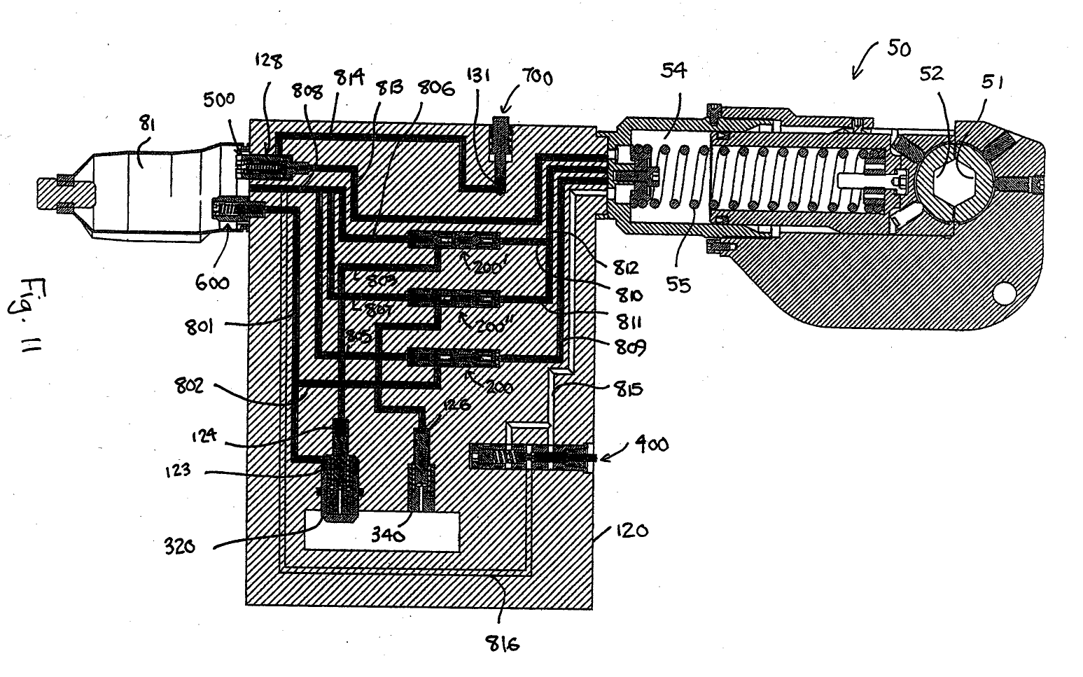

Referring to FIGS. 4 to 6, the high pressure relief valve assembly 500 has a cylindrical relief valve chamber 501 with an inlet port 502 located at an upstream end of the relief chamber 501. The inlet port 502 communicates the relief valve chamber 501 with the head chamber 54, via a high pressure relief line 813, as depicted in FIGS. 10 and 11. The inlet port 502 defines an annular inlet seat 503 at the downstream end of the inlet port 502. A primary outlet port 512 is located at a downstream end of the relief valve chamber 501. The primary outlet port 512 communicates the relief valve chamber 501 with the hydraulic fluid supply 81, as depicted in FIGS. 10 and 11. At least one, and here four, secondary outlet ports 514 are located between the inlet port 502 and the primary outlet port 512. The secondary outlet ports 514 communicate with the indicator assembly 700 via an indicator line 814, as depicted in FIGS. 10 and 11. The secondary outlet ports 514 are formed in the side wall of a relief valve body 515 which defines the relief valve chamber 501. As best depicted in FIGS. 4 and 5, the secondary outlet ports are formed in a reduced outer diameter section 516 of the relief valve body 515. The primary relief valve assembly 500 is located within a cylindrical high pressure relief valve cavity 128 formed in the body block 120, as best depicted in FIGS. 10 and 11. The reduced outer diameter section 516 of the relief valve body 515 thus defines, with the wall of the high pressure relief valve cavity 128, an annular void which allows each of the secondary outlet ports 514 to communicate with the indicator line 814. The secondary outlet ports 514 are located towards the upstream end of the relief valve chamber 501.

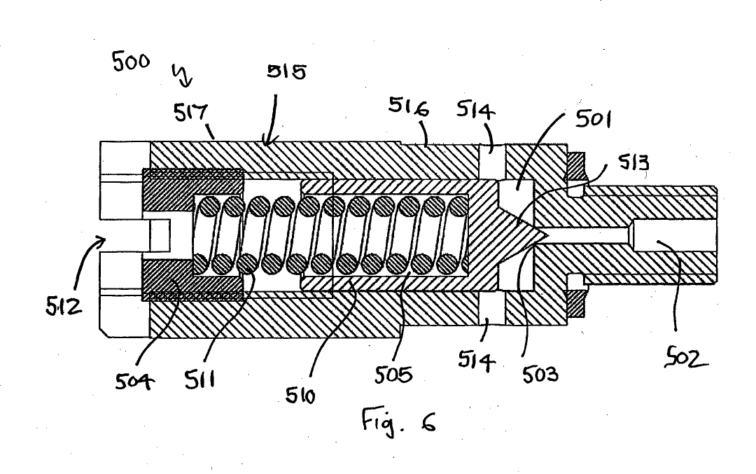

A cylindrical relief valve member 510 is mounted in the relief valve chamber 501. The relief valve member 510 has a conical projection 513 formed at its upstream end. The relief valve member 510 is displaceable between a closed position (depicted in FIG. 6), where the projection 513 sealingly engages the inlet valve seat 503 to at least substantially prevent the flow of hydraulic, fluid through the inlet port 502, and an open position. In the open position, the relief valve member 510 allows the flow of hydraulic fluid through the inlet port 502 into the relief valve chamber 501. Hydraulic fluid passing through the inlet port 502 is able to flow through the secondary outlet ports 514 into the indicator line 814 to the indicator assembly 700. The relief valve member 510 is sized to allow a narrow elongate annular gap between the relief valve member 510 and the wall 507 of the relief valve chamber 501, thereby defining a restricted flow path for allowing the hydraulic fluid flowing through the inlet port 502 also to flow around the relief valve member 210 and through the primary outlet port 512 into the hydraulic fluid supply 81. The relatively narrow elongate annular passage provides for a restricted flow, ensuring that there is sufficient back pressure for the hydraulic fluid flowing through the secondary outlet ports 514 to pressurize the indicator line 814 (and indicator assembly 700) before the pressure is vented to the typically atmospheric pressure within the hydraulic fluid supply 81. In the arrangement depicted, the cylindrical portion of the relief valve member 510 has a length of 11.8 mm and a nominal diameter of 6.8 mm, providing a restricted annular flow path with a width of about 0.04 to 0.06 mm and length of 11.8 mm. A further restricted flow path communicating the inlet port 502 with the hydraulic fluid supply 81 is provided by way of a narrow passage defined between a flattened region 517 of the relief valve body 515 and the wall of the high pressure relief valve cavity 128. Hydraulic fluid flowing through the inlet port 502 and through the secondary outlet ports 514 is able to flow along the flattened region 517 directly into the hydraulic fluid supply 81. This flow is again sufficiently restricted to maintain the back pressure for pressurization of the indicator line 814.

A relief valve spring 511 is mounted in the relief valve chamber 501 and extends between a spring detent 504 mounted in the relief valve chamber 501 towards the primary outlet 512 and the base of a recess 505 formed in the downstream end of the relief valve member 510. The relief valve spring 511 biases the relief valve member 510 to the closed position, as depicted in FIG. 6. The relief valve spring 511 is configured such that the relief valve member 510 is displaced to its open position once a predetermined high pressure has been reached in the high pressure relief line 813 (and head chamber 54), correlating to the crimp pressure applied between the first and second jaws 51, 52 required for performing an adequate crimp or splice. The predetermined high pressure will typically be of the order of 10,000 psi (about 70 mPa). The predetermined high pressure is factory adjustable by screw threading the spring detent 504 along the internally threaded wall of the relief valve body 515, adjusting the pressure applied to the relief valve spring 511. A lock nut (not depicted) locks the spring detent 504 in place once the correct high pressure has been set.

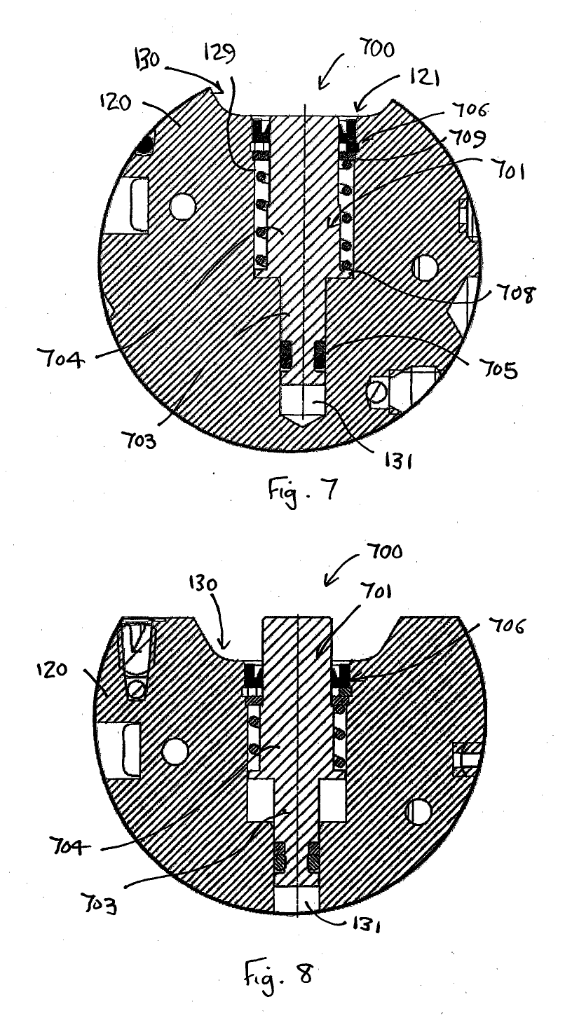

Referring to FIGS. 7 and 8, the indicator assembly 700 includes an indicator member 701 mounted in an indicator cavity 129 formed in the top of the body block 120. The opening 121 defining the open end of the indicator cavity 129 is provided in a recessed region 130 of the outer surface of the body block 120. When in the retracted position, depicted in FIG. 7, the top of the indicator member 701 is at least substantially flush with the recessed region 130, whilst in the extended position depicted in FIG. 8, the indicator member 701 extends through the opening 121. The indicator member 701 has a relatively narrow cylindrical valve member stem 703, here having a diameter of approximately 5.2 mm, and a broader cylindrical valve member body 704, here having a diameter of approximately 8 mm, coaxially extending from the valve member stem 703. The valve member stem 703 is received in a reduced diameter portion of the indicator cavity which defines a indicator chamber 131. As depicted in FIGS. 10 and 11, the indicator chamber 131 communicates directly with the indicator line 814. An annular seal and back up ring arrangement 705 is mounted on the indicator member stem 703 and sealingly engages the wall of the indicator chamber 131, preventing any hydraulic fluid from leaking out of the indicator chamber 131. The indicator member 701 is retained in the indicator cavity 129 by way of a retainer arrangement 706 which incorporates a circlip. The indicator member 701 is biased towards the retracted position by way of an indicator spring 702 that bears against a flange 708 provided at the base of the indicator member body 704 and a washer 709 which in turn bears against the retainer arrangement 706.

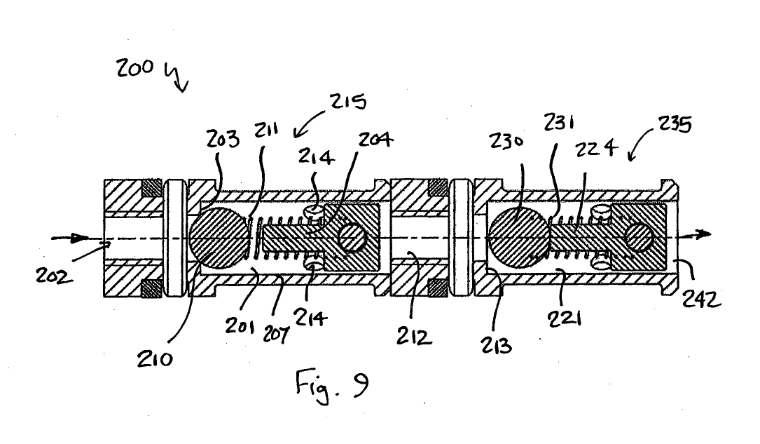

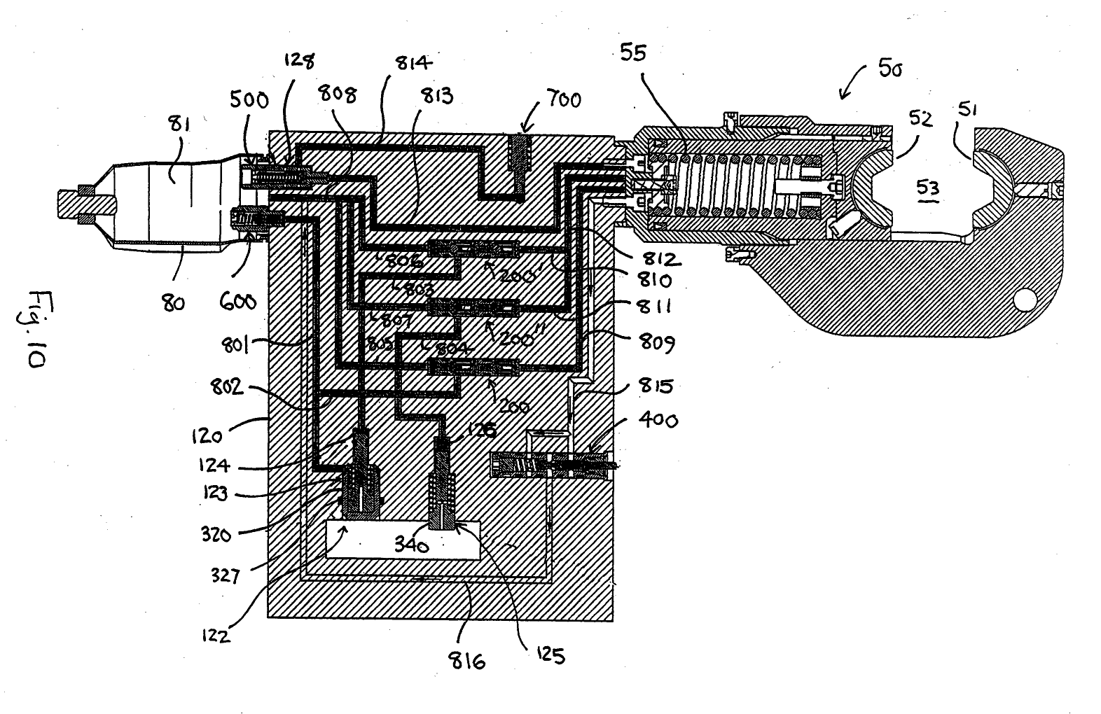

The configuration of each of the shuttle valve assemblies 200, 200′, 200″ is identical and is depicted in further detail in FIG. 9. The shuttle valve assembly 200 has a primary chamber 201 with a primary inlet port 202 located at an upstream end of the primary chamber 201. The primary inlet port 202 communicates the primary chamber 201 with the hydraulic fluid supply 81. The primary inlet port 202 defines an annular inlet seat 203 at the downstream end of the primary inlet port 202. An inlet stop 204 is located in the primary chamber 201 downstream of the inlet valve seat 203.

An inlet valve member 210 is located between the inlet valve seat 203 and the inlet stop 204. The inlet valve member 210 is displaceable along an inlet valve path between a closed position (depicted in FIG. 9), sealingly engaging the inlet valve seat 203 to at least substantially prevent the flow of hydraulic fluid through the primary inlet port 202, and an open position engaging the inlet stop 204. In the open position, the inlet valve member 210 allows the flow of hydraulic fluid through the primary inlet port 202. The inlet valve member 210 is also sized to allow a gap between the inlet valve member 210 and the wall 207 of the primary chamber 201, thereby allowing the hydraulic fluid flowing through the primary inlet port 202 to flow around the inlet valve member 210 through the primary chamber 201. In the arrangement depicted, the inlet valve member 210 is in the form of a ball, with the primary chamber 201 being cylindrical. In the particular arrangement depicted, an inlet valve spring 211 is located in the primary chamber 201, extending between the inlet stop 204 and the inlet valve member 210. The inlet valve spring 211 is a compression spring and acts to bias the inlet valve member 210 towards the inlet valve seat 203, thereby biasing the inlet valve member 210 to its closed position.

A primary outlet port 212 is located at a downstream end of the primary chamber 201. The primary outlet port 212 communicates the primary chamber 201 with the actuable member of the tool, being the second jaw 52. The primary outlet port 212 defines an annular outlet valve seat 213 at the downstream end thereof.

A charging port 214 is located between the primary inlet port 202 and the primary outlet port 212. The charging port 214 communicates the primary chamber 201 with an hydraulic pump, comprising the first piston 321 and first piston chamber 123 in the case of the first shuttle valve assembly 200, the second piston 331 and piston chamber 124 in the case of the second shuttle valve assembly 200′ and the third piston 341 and third piston chamber 126 in the case of the third shuttle valve assembly 200″, as best depicted in FIGS. 10 and 11. In the particular arrangement depicted, there are four charging ports 214 spaced about the wall 207 of the primary chamber 201.

An outlet stop 224 is located downstream of the outlet valve seat 213. An outlet valve member 230 is located between the outlet valve seat 213 and the outlet stop 224. The outlet valve member 230 is displaceable along an outlet valve path between a closed position sealingly engaging the outlet valve seat 213 to at least substantially prevent the flow of hydraulic fluid through the primary outlet port 212, and an open position (depicted in FIG. 9) engaging the outlet stop 224. In the open position, the outlet valve member 230 allows the flow of hydraulic fluid through the primary outlet port 212. In the arrangement depicted, the outlet valve member 230 is in the form of a ball. In the depicted embodiment, the outlet stop 224 and outlet valve member 230 are housed within a cylindrical secondary chamber 221.

The outlet valve member 230 is sized to allow a gap between the outlet valve member 230 and the wall 227 of the secondary chamber 221, thereby allowing the hydraulic fluid flowing through the primary outlet port 212 to flow around the outlet valve member 230 through the secondary chamber 221. The secondary chamber 221 is of identical size and configuration to the primary chamber 201, and the outlet valve member 230 is also of identical size to the inlet valve member 210. In the arrangement depicted, an outlet valve spring 231 is located in the secondary chamber 221, extending between the outlet stop 213 and the outlet valve member 230. The outlet valve spring 231 is identical to the inlet valve spring 211, being a compression spring which acts to bias the outlet valve member 230 towards the outlet valve seat 213, thereby biasing the outlet valve member 230 to its closed position. A secondary outlet port 242 is defined at the downstream end of the secondary chamber 221.

In the arrangement depicted, the shuttle valve assembly 200 comprises a valve body that defines the primary and secondary chambers 201, 221 and which is housed within a cylindrical cavity 127 defined in the body block 120, as shown in FIGS. 3 to 5. In particular, the valve body of the first shuttle valve assembly 200 is located within a first shuttle valve cavity 127, the valve body of the second shuttle valve assembly 200′ is located in a second shuttle valve cavity 127′ and the valve body of the third shuttle valve assembly 200″ is located within a third shuttle valve cavity 127″.

In the particular configuration depicted, the valve body of the shuttle valve assembly 200 comprises a primary valve cartridge 215 and a secondary valve cartridge 235 that is identical to the primary valve cartridge 215. The primary valve cartridge 215 defines the primary chamber 201 whilst the secondary valve cartridge 235 defines the secondary chamber 221. The upstream end portion of the primary valve cartridge 215 defines the primary inlet port 202. The upstream portion of the secondary valve cartridge 235 defines the primary outlet port 212 and the downstream portion of the secondary valve cartridge 235 defines the secondary outlet port 242. Each of the shuttle valve assemblies 200, 200′, 200″ is retained within the respective shuttle valve cavity 127, 127′, 127″ by a retainer 260.

The charging ports 214 are located in a reduced outer diameter section of the primary valve cartridge 215 which defines, with the wall of the shuttle valve cavity 127, an annular void which allows each of the charging ports 214 to communicate with a respective charging line 802, 803, 804 as discussed below.

The hydraulic circuits of the hydraulic crimping tool, and operative relationship between components thereof, is schematically depicted in FIGS. 10 and 11. FIG. 10 depicts the tool at commencement of the crimping operation, whilst FIG. 11 depicts the tool at completion of the crimping operation. The block body 120 defines a series of hydraulic pressure lines that operatively communicate various components of the crimping tool. A low pressure relief line 801 communicates the first piston chamber 123 with the hydraulic fluid supply 81 via the low pressure relief valve assembly 600.

A low pressure charging line 802 communicates the first piston chamber 123 with the charging ports 214 of the first shuttle valve assembly 200. In the arrangement depicted, the low pressure charging line 802 branches from the low pressure relief line 801. A first high pressure charging line 803 communicates the second piston chamber 124 with the second shuttle valve assembly 200′. A second high pressure charging line 804 communicates the second piston chamber 124 with the charging ports 214 of the third shuttle valve 200″.

A first supply line 805 communicates the hydraulic pressure supply 81 with the primary inlet port 202 of the first shuttle valve assembly 200. A second, supply line 806 communicates the hydraulic pressure supply 81 with the primary inlet port 202 of the second shuttle valve assembly 200′. A third supply line 807 communicates the hydraulic pressure supply 81 with the primary inlet port 202 of the third shuttle valve assembly 200″. In the arrangement depicted, the first, second and third supply lines 805, 806, 807 branch off a primary supply line 808 which communicates directly with the hydraulic fluid supply 81.

A low pressure actuation line 809 communicates the secondary outlet port 242 (and, indirectly, the primary outlet port 212) of the first shuttle valve assembly 200 with a head chamber 54 defined in the head assembly 50. A first high pressure actuation line 810 communicates the secondary outlet port 242 (and, indirectly, the primary outlet port 212) of the second shuttle valve assembly 200′ with the head chamber 54. A second high pressure actuation line 811 communicates the secondary outlet port 242 (and, indirectly, the primary outlet port 212) of the third shuttle valve assembly 200″ with the head chamber 54. The first and second high pressure actuation lines 810, 811 branch off a primary high pressure actuation line 812 which communicates directly with the head chamber 54.

A first return line 815 communicates the head chamber 54 with the head pressure return valve assembly 400. A second return line 816 communicates the head pressure return valve assembly 400 with the hydraulic fluid supply 81 via the primary supply line 808.

Operation of the hydraulic crimping tool will now be described with particular reference to FIGS. 3, 10 and 11. The connector or splice to be crimped is firstly located within the recess 53 defined between the first and second opposing jaws 51, 52. A jaw return spring 55, in the form of a tension spring, is mounted between an end wall of the head chamber 54 and the second jaw 52 to bias the second jaw 52 to the open position depicted in FIG. 11, allowing location of the connector or splice in the recess 53.

The hydraulic crimping tool is then operated by depressing the operating trigger 14, which results in electrical power provided by the battery pack 20 powering the motor and gearbox assembly 70, which in turn rotatably drives the crankshaft 312. Resultant rotation of the crankshaft 312 provides reciprocating motion of the first and second piston assemblies 320, 340. The first and second cam lobes 313, 314 are configured with opposing geometries, here with the nose (i.e. the highest part of the lobe) of each cam lobe 313, 314 separated by 180 degrees, such that the first and second piston assemblies 320, 340 reciprocate in opposing phases.

Rotation of the first cam lobe 313 results in the first and second pistons 321, 331 reciprocating in unison by contact of the first cam follower face 323 with the first cam lobe 313 and the action of the first spring 328, which keeps the first cam follower face 323 in contact with the first cam lobe 313. The first and second pistons 321, 331 reciprocate between discharge and suction cycles of the dual first pump defined by the first piston assembly 320 and first piston mounting cavity 122. In the discharge cycle, the first piston assembly 320 extends into the piston mounting cavity 122, thereby increasing pressure in the first and second piston chambers 123, 124. In the suction cycle, the first piston assembly 320 is retracted from the first piston mounting cavity 122, thereby reducing pressure in the first and second piston chambers 123, 124.

Rotation of the second cam lobe 314 results in the third pistons 341 reciprocating by contact of the second cam follower face 343 with the second cam lobe 314 and the action of the second spring 338, which keeps the second cam follower face 343 in contact with the second cam lobe 314. The third piston 341 reciprocates between discharge and suction cycles of the second pump defined by the second piston assembly 340 and second piston mounting cavity 125. In the discharge cycle, the second piston assembly 340 extends into the second piston mounting cavity 125, thereby increasing pressure in the third piston chamber 126. In the suction cycle, the second piston assembly 340 is retracted from the second piston mounting cavity 125, thereby reducing pressure in the third piston chamber 126. Due to the offset axes of the first and second cam lobes 313, 314, whilst the first piston assembly 320 is in the discharge cycle, the second piston assembly 340 is in the suction cycle and vice versa. This assists in balancing the load on the motor and gearbox assembly 70 and improves smoothness of operation.

At commencement of operation, whilst the first and second jaws 51, 52 are separated, no load is applied to the actuable second jaw 52.

During the discharge cycle of the first piston assembly 320, pressure within the first piston chamber 123 increases, driving hydraulic fluid in the first piston chamber 123 through the low pressure charging line 802 (via the low pressure relief line 801) into the primary chamber 201 of the first shuttle valve assembly 200, thereby increasing the pressure in the primary chamber 201. The hydraulic fluid driven from the first piston chamber 123 along the low pressure relief line 801 also acts on the low pressure relief valve assembly 600. The low pressure relief valve assembly 600 is, however, spring biased to a sealed configuration, adapted only to open when pressure in the low pressure relief line 801 reaches a predetermined low pressure threshold. The predetermined low pressure threshold is set slightly higher than the pressure exerted by the return spring 55 at full extension, against which the pressure within the head chamber 54 (which is directly related and substantially identical to, the pressure in the low pressure relief line 801) must act to displace the second jaw 52 towards the splice or connector located in the recess 53 during the initial high-volume low pressure phase of operation. The predetermined low pressure threshold is factory adjustable by a screw adjuster applying pressure against the internal biasing spring of the low pressure relief valve assembly 600. A lock nut locks the screw adjuster in place once the correct low pressure threshold has been set.

Referring now to FIG. 9, depicting the first shuttle valve assembly 200, the increased pressure in the primary chamber 201, during the discharge cycle of the first piston assembly 320 will, together with the inlet valve spring 211, drive the inlet valve member 210 along the inlet valve path, into its closed position against the inlet valve seat 203, thereby sealing the primary inlet port 202. As pressure in the primary chamber 201 increases beyond the pressure in the head chamber 54 during the discharge cycle, the pressure in the primary chamber 201 will act on the outlet valve member 230 against the outlet valve spring 231 and pressure in the head chamber 54 to drive the outlet valve member 230 to its open position against the outlet stop 224. This allows the hydraulic fluid at increased pressure in the primary chamber 201 to be driven at the increased pressure out of the primary outlet port 252 and secondary outlet port 242, and through the low pressure actuation line 809 to the head chamber 54, thereby increasing pressure in the head chamber 54. The increasing pressure in the head chamber 54 will then act to displace the second jaw 52 towards the first jaw 51, against the biasing return force of the jaw return spring 54.

In the suction cycle of the first piston assembly 320, the pressure in the first piston chamber 123 reduces, drawing hydraulic fluid at reduced pressure back from the primary chamber 201 of the first shuttle valve assembly 200, through the low pressure charging line 802 back into the first piston chamber 123. When the pressure within the primary chamber 201 reduces sufficiently for pressure within the hydraulic fluid supply 81 (which would typically be at atmospheric pressure) to overcome the reduced pressure in the primary chamber 201 and the inlet valve spring 211, the inlet valve member 210 is driven along the inlet valve path from its closed position, seated against the primary inlet valve 203, to its open position against the inlet stop 204. With the inlet valve member 210 in its open position, hydraulic fluid is drawn from the hydraulic fluid supply 81 through the first supply line (via the primary supply line 808) into the low pressure primary chamber 201. The reduced pressure in the primary chamber 201 during the suction cycle also allows the higher pressure in the head chamber 84 and the outlet valve spring 231 to drive the outlet valve member 230 along the outlet valve path from the outlet stop 224 to its closed position against the outlet valve seat 213, sealing the primary valve outlet 212.

With each successive discharge and suction cycle, the pressure in the head chamber 54 increases, with further hydraulic fluid being supplied from the hydraulic fluid supply 81 during each suction cycle. With the pressure in the head chamber 54 increasing in each successive discharge cycle, the pressure in the primary chamber 201 also increases with each cycle, resulting in a corresponding pressure increase in the low pressure relief line 801. When the pressure in the low pressure relief line 801 reaches the predetermined low pressure threshold, which will generally be set to occur as soon as, or immediately after, the second jaw 52 (and first jaw 51) engages the splice or connector, the low pressure relief valve assembly 600 opens, thereby relieving pressure in the low pressure charging line 802 and primary chamber 201, equalizing it with the (typically atmospheric) pressure in the hydraulic fluid supply 81 and first supply line 805. The first shuttle valve assembly 200 thus ceases its operation once this threshold pressure has been attained. This signifies the end of the high-volume, low pressure initial phase of operation during which the second jaw 52 will be rapidly displaced towards the first jaw 51 until the gap therebetween is reduced sufficiently to have the connector or splice contacted by both jaws 51, 52, at which point the jaw pressure required to further displace the second jaw 52 is greatly increased, as the connector/splice is crushed between the jaws 51, 52. It is primarily the relatively large effective cross-sectional area of the first piston chamber 123 that provides for the initial rapid displacement of the second jaw 52, given the resultant high hydraulic fluid flow rate during each discharge cycle of the first piston 321.

As the first piston assembly 320 reciprocates through each discharge and suction cycle as described above, pressure within the second piston chamber 124 increases and decreases in phase with the pressure increase and decrease in the first piston chamber 123. Accordingly, during each discharge cycle of the first piston assembly 320, pressure within the second piston chamber 124 increases, driving hydraulic fluid in the second piston chamber 124 through the first high pressure charging line 803 into the primary chamber 201 of the second shuttle valve assembly 200′, thereby increasing the pressure in the primary chamber 201. The second shuttle valve assembly 200′ will thus operate in the same manner as the first shuttle valve assembly 200, driving the hydraulic fluid at increased pressure out of the primary outlet port 212 and secondary outlet port 242 of the second shuttle valve assembly 200′, through the first high pressure actuation line 810 to the head chamber 54, thereby again increasing pressure in the head chamber 54. Accordingly, during the discharge cycle of the first piston assembly 320, both the first and second pistons 321, 331 act to increase the pressure in the head chamber 54, acting to displace the second jaw 52 towards the first jaw 51.

In each suction cycle of the first piston assembly 320, the pressure in the second piston chamber 124 reduces, drawing hydraulic fluid at reduced pressure back from the primary chamber 201 of the second shuttle valve assembly 200′ through the first high pressure charging line 803 back into the second piston chamber 124. This again results in hydraulic fluid being drawn from the hydraulic fluid supply 81, through the second supply line 802 into the low pressure primary chamber 201 of the second shuttle valve assembly 200′.

The second piston 331 and second shuttle valve assembly 200′ continue to operate in unison with the first piston 321 and first shuttle valve assembly 200 as pressure in the head chamber 54 increases. Whilst still in operation prior to activation of the low pressure relief valve 600, the first piston 321 and first shuttle valve assembly 200 are), the first pump (defined by the first piston 321 and first piston chamber 123) provide a much greater hydraulic fluid flow rate than the second pump (defined by the second piston 321 and second piston chamber 124) and second shuttle valve assembly 200′, given the greater effective cross-sectional area of the first piston chamber 123. After the low pressure relief valve 600 has opened, signaling the end of the high-volume low pressure initial phase of operation, the second pump assembly and the second shuttle valve assembly 200′ continue to operate to continue increasing pressure within the head chamber 54, albeit at a slower rate.

Throughout operation of the first piston assembly 320, the second piston assembly 340 also reciprocates through successive discharge and suction cycles, 180 degrees out of phase with the first piston assembly 320 as noted above. As the second piston assembly 340 reciprocates through its discharge and suction cycles, pressure within the third piston chamber 126 increases and decreases (out of phase with the pressure increase and decrease in the first and second piston chambers 123, 124). During each discharge cycle of the second piston assembly 340, pressure within the third piston chamber 126 increases, driving hydraulic fluid in the third piston chamber 26 through the second high pressure charging line 804 into the primary chamber 201 of the third shuttle valve assembly 200″, thereby increasing the pressure in the primary chamber 201. The third shuttle valve assembly 200′ operates in the same manner as the first and second shuttle valve assemblies 200, 200′, driving the hydraulic fluid at increased pressure out of the primary outlet port 212 and secondary outlet port 242 of the third shuttle valve assembly 200′, through the second high pressure actuation line 811 to the head chamber 54, increasing pressure in the head chamber 54. This occurs, however, out of phase with the first and second shuttle valve assemblies 200, 200′ whilst the primary outlet ports 212 of the first and second shuttle valve assemblies 200, 200′ are sealed.

During each suction cycle of the second piston assembly 340, the pressure in the third piston chamber 126 reduces, drawing hydraulic fluid at reduced pressure back from the primary chamber 201 of the third shuttle valve assembly 200″ through the second high pressure charging line 804 back into the third piston chamber 126. This again results in hydraulic fluid being drawn from the hydraulic fluid supply 81, through the third supply line 803 into the low pressure primary chamber 201 of the third shuttle valve assembly 200″.

Throughout'operation, the increase in pressure in the head chamber 54 increases fluid pressure in the high pressure relief line 813. The high pressure relief valve assembly 500 is biased into the closed position by way of the relief valve spring 511, isolating the high pressure relief line 813 from the hydraulic fluid supply 81 and the indicator line 814. Once the pressure in the high pressure relief line 814 reaches the predetermined high pressure (which, as noted above, will typically be of the order of 10,000 psi/about 70 mPa) the biasing force of the relief valve spring 511 will be overcome, such that the pressure will drive the relief valve member 510 to the open position, allowing the flow of hydraulic fluid through the inlet port 502 into the relief valve chamber 501 and through the secondary outlet ports 514 into the indicator line 814 to the indicator chamber 131. This increased pressure in the indicator chamber 131 will act on the indicator member 701, against the biasing force of the indicator spring 702, to drive the indicator member 701 from its retracted position to the extended position as depicted in FIGS. 8 and 11. The hydraulic fluid will also flow into the hydraulic fluid supply 81, through the restricted flow paths defined around the relief valve member 210 and along the flattened region 517 along the exterior of the relief valve body 515, thereby maintaining back pressure to allow sufficient pressurization of the indicator line 814 to activate the indicator assembly 700. Continued flow of the hydraulic fluid into the hydraulic fluid supply 81, which would typically be at atmospheric pressure, will result in the pressure within the indicator line 814 reducing again, resulting in the indicator valve member 701 retracting back to its retracted position under the biasing force of the indicator spring 702. As pressure in the relief valve line 813 is vented to the hydraulic fluid supply 881, pressure in the head chamber 54 also reduces, resulting in the dual return spring to draw the second jaw 52 back to the open position, allowing removal of the crimped connector or splice. As pressure drops, the relief valve member 510 will also be displaced back to its closed position under action of the relief valve spring 511.

Activation of the indicator assembly 700, albeit only a temporary activation, provides the operator with a visual indication that the crimping operation is complete, with the appropriate crimping pressure having been applied to the splice or connector to be crimped. This acts as a prompt to the operator to release the operating trigger 14, disconnecting power from the motor and gearbox assembly 70. Where the operator does not have clear visibility of the top of the tool, and thus the indicator member 701, the operator may readily place a finger into the recessed region 130 of the outer surface of the body block 120 and sense activation of the indicator assembly 700 by touch. Whilst opening of the high pressure relief valve assembly 500 may also provide an audible “pop” and vibration, which might be sensed by the operator upon completion of the crimping operation, noisy environments or the use of hearing protection may prevent the audible signal being identified by the operator. Similarly, the vibration that will occur upon opening of the relief valve assembly 500 is often not readily identified.

At any time during the crimping operation, the operation may be ceased and pressure within the head assembly relieved by depressing a release trigger 15, mounted above the operating trigger 14. The release trigger 15 which in turn operates the head pressure return valve assembly 400, communicating the head chamber 54 with the hydraulic fluid supply 81 via the first return line 815, head pressure return valve assembly 400, second return line 816 and primary supply line 808. The pressure within the head chamber 54 is thus released, allowing the crimping operation to be aborted.

It is envisaged that the hydraulic drive arrangement defined by the motor and gearbox assembly 70, pump assembly 300 and first, second and third shuttle valve assemblies 200, 200′, 200″ may be replaced with other forms of hydraulic drive arrangement that act to draw hydraulic fluid from the hydraulic fluid supply 81 and drive the hydraulic fluid under increasing pressure into the head chamber 54. For example, rather than using two pumps comprising a dual phase first pump and single phase second pump, it is envisaged that other forms of pump arrangement may be utilized, including one single phase pump. It is also envisaged that other forms of valve assembly may be utilized in place of the specific shuttle valve assemblies 200, 200′, 200″ described above. Whilst the hydraulically actuated tool has been described in terms of a hydraulic crimping tool, it is also envisaged that the tool may take the form of other hydraulically actuated tools. A person skilled in the art will also appreciate various other possible modifications to the arrangements described.

1. An hydraulically actuated tool comprising:
a body;
an hydraulic fluid supply;
a head chamber;
an actuable member adapted to be actuated by pressure within said head chamber;
an hydraulic drive arrangement configured to draw hydraulic fluid from said hydraulic fluid supply and drive said hydraulic fluid under increasing pressure into said head chamber;
an indicator assembly mounted in said body and having an indicator member displaceable between a retracted position and an extended position protruding from said body; and
a pressure relief valve assembly adapted to open upon pressure within said head chamber reaching a predetermined threshold pressure;
wherein opening of said pressure relief valve assembly provides fluid communication between said head chamber and said indicator assembly to drive said indicator member to said extended position and provides fluid communication between said head chamber and said hydraulic fluid supply.

2. The tool of claim 1 further comprising an indicator chamber, wherein said indicator assembly is received in said indicator chamber and opening of said pressure relief valve assembly provides fluid communication between said head chamber and said indicator chamber to drive said indicator member to said extended position under pressure within said indicator chamber.

3. The tool of claim 1, wherein said indicator assembly further comprises a spring biasing said indicator member to said retracted position.

4. The tool of claim 1, wherein, in said extended position, said indicator member extends through an opening provided in a recessed region of an outer surface of said body.

5. The tool of any one of claims claim 14, wherein said pressure relief valve assembly comprises:
a relief valve chamber;
an inlet port located at an upstream end of said relief valve chamber and in fluid communication with said head chamber.
a primary outlet port located at a downstream end of said relief valve chamber and in fluid communication with said hydraulic fluid supply;
a secondary outlet port located between said inlet port and said primary outlet port and in fluid communication with said indicator assembly;
a relief valve member located in said relief valve chamber, said relief valve member being displaceable between a closed position sealing said inlet port to at least substantially prevent flow of hydraulic fluid through said inlet port and an open position allowing the flow of hydraulic fluid through said inlet port, out of said secondary outlet port and around said relief valve member through said outlet port; and
a relief valve spring biasing said relief valve member to said closed position.

6. The tool of claim 2, wherein said indicator assembly further comprises a spring biasing said indicator member to said retracted position.

7. The tool of claim 2, wherein, in said extended position, said indicator member extends through an opening provided in a recessed region of an outer surface of said body.

8. The tool of claim 3, wherein, in said extended position, said indicator member extends through an opening provided in a recessed region of an outer surface of said body.

9. The tool of claim 2, wherein said pressure relief valve assembly comprises:
a relief valve chamber;
an inlet port located at an upstream end of said relief valve chamber and in fluid communication with said head chamber.
a primary outlet port located at a downstream end of said relief valve chamber and in fluid communication with said hydraulic fluid supply;
a secondary outlet port located between said inlet port and said primary outlet port and in fluid communication with said indicator assembly;
a relief valve member located in said relief valve chamber, said relief valve member being displaceable between a closed position sealing said inlet port to at least substantially prevent flow of hydraulic fluid through said inlet port and an open position allowing the flow of hydraulic fluid through said inlet port, out of said secondary outlet port and around said relief valve member through said outlet port; and
a relief valve spring biasing said relief valve member to said closed position.

10. The tool of claim 3, wherein said pressure relief valve assembly comprises:
a relief valve chamber;
an inlet port located at an upstream end of said relief valve chamber and in fluid communication with said head chamber. a primary outlet port located at a downstream end of said relief valve chamber and in fluid communication with said hydraulic fluid supply;
a secondary outlet port located between said inlet port and said primary outlet port and in fluid communication with said indicator assembly;
a relief valve member located in said relief valve chamber, said relief valve member being displaceable between a closed position sealing said inlet port to at least substantially prevent flow of hydraulic fluid through said inlet port and an open position allowing the flow of hydraulic fluid through said inlet port, out of said secondary outlet port and around said relief valve member through said outlet port; and
a relief valve spring biasing said relief valve member to said closed position.

11. The tool of claim 4, wherein said pressure relief valve assembly comprises:
a relief valve chamber;
an inlet port located at an upstream end of said relief valve chamber and in fluid communication with said head chamber.
a primary outlet port located at a downstream end of said relief valve chamber and in fluid communication with said hydraulic fluid supply;
a secondary outlet port located between said inlet port and said primary outlet port and in fluid communication with said indicator assembly;
a relief valve member located in said relief valve chamber, said relief valve member being displaceable between a closed position sealing said inlet port to at least substantially prevent flow of hydraulic fluid through said inlet port and an open position allowing the flow of hydraulic fluid through said inlet port, out of said secondary outlet port and around said relief valve member through said outlet port; and
a relief valve spring biasing said relief valve member to said closed position.
